(19) United States
(12) Patent Application Publication
(10) Pub. No.: US 2018/0084100 A1
(43) Pub. Date: Mar. 22, 2018

(54) MULTI-PARTY EMERGENCY CALLS

(71) Applicant: T-Mobile USA, Inc., Bellevue, WA (US)

(72) Inventor: Ramaswamy Chockalingam, Bellevue, WA (US)

(73) Assignee: T-Mobile USA, Inc.

(21) Appl. No.: 15/269,546

(22) Filed: Sep. 19, 2016

(51) Int. Cl. H04M 1/725; H04W 4/22; H04M 3/56; H04M 3/42; H04L 29/06

(52) U.S. Cl. CPC H04M 1/72541; H04W 4/22; H04M 3/56; H04M 2242/04; H04M 1/72552; H04M 3/42357; H04L 65/1016; H04M 1/72583

(57) ABSTRACT

A user of a communications device such as a smartphone may place calls to emergency services using the device. The device may be configured to automatically initiate a conference call in response to a user request to initiate an emergency services call. For example, the user may provide configuration information that includes an emergency contact person and a medical care facility and, upon receiving a request from the user to place an emergency call, the device may initiate a multi-party voice call or conference call to an emergency dispatch center, the emergency contact person, and the medical care facility.

### BACKGROUND

In the United States and Canada, the telephone number “911” is reserved for use only in emergencies, in order to initiate a telephone call to an emergency dispatch center that can send emergency responders to the location of the caller. In many other countries, the number 112 is reserved for similar purposes. In many areas, calling “911” or “112” also gives the caller's location to the emergency dispatch center.

Mobile communications, such as may at times be used to initiate emergency calls, are increasingly provided by packet-based communications systems, using a communications infrastructure known as IMS (IP multimedia subsystem). IMS can be configured to provide voice communications, video communications, audio and/or video conferencing, user-to-user messaging, multi-party messaging, and so forth.

An IMS system has elements that are designed specifically to support emergency service calls. In particular, an IMS system may be configured to have an E-CSCF (emergency call session control function) that is responsible for forwarding call requests to the appropriate emergency dispatch center. A P-CSCF (proxy call session control functions) of an IMS system is configured to recognize emergency calls and to forward them to an E-CSCF that is within the same IMS domain.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a block diagram illustrating entities and elements of a system that may be used for implementing multi-party emergency calling services.

FIG. 2 is a flow diagram illustrating an example method of automatically placing a multi-party emergency service call in response to user requests.

FIG. 3 is a diagram illustrating high-level communications that may occur between entities and elements of a communications system when initiating multi-party emergency service calls.

FIG. 4 is a block diagram of an example communications device.

FIG. 5 is a block diagram of an example computing device that may be used to implement components and functions of a communications system.

### DETAILED DESCRIPTION

The described implementations provide devices, systems, and methods that allow a communication device to initiate, in response to a user request to place an emergency call, a multi-party voice communication session with parties that include an emergency dispatch center and a pre-designated emergency contact person.

A communication device such as a mobile phone may be configured by its user with emergency configuration information. The emergency configuration information may include preferences indicating how the phone is to implement calls to emergency services. Specifically, the emergency configuration information may indicate whether the phone is to automatically initiate a voice communication session with multiple parties when the user initiates an emergency call. During a multi-party voice communication session, each party can hear each of the other parties.

As an example, a mobile phone may be configured to initiate a conference call to an emergency dispatch center, a designated emergency contact person for the caller, and a medical services provider. Emergency configuration information may be provided during configuration of the mobile phone to specify a telephone number of the emergency contact person. The emergency configuration information may also indicate a preferred or available medical care facility and its telephone number. Alternatively, a suitable medical care facility may be identified automatically, based on the location of the mobile phone.

A user of a communication device can initiate an emergency call by dialing “911” on the device or by selecting a graphical icon or other control that is displayed by the device for this purpose. In response, the device initiates a voice call to an emergency dispatch center. In addition, the device attempts to create a multi-party voice communication session, sometimes referred to as a conference call that includes the emergency dispatch center and the previously designated emergency contact person. In some cases, the multi-party communication session may also be configured to include a medical care facility. For example, the medical care facility may be a facility to which responders may transport the victim of an accident.

During a multi-party communication session, all the participants in the session can speak with and be heard by each other. This may be useful and may save time in many situations. For example, there may be a situation in which a hospital needs to obtain prior verbal approval for medical procedures. A conference call allows the hospital to get such approval from either the caller or the emergency contact person, without requiring a separate communication. Similarly, the caller or the emergency contact person may be able to provide vital information such as blood type, current medications, and other information to first responders and/or to the medical care facility.

A selectable control for placing a multi-party emergency call may be made available on the lock screen of a device, so that a user can initiate a multi-party emergency call without unlocking the phone. A control such as this may be represented as a graphical icon, and may be implemented as a “shortcut” in some device operating systems. In some cases, the device may display two icons, corresponding respectively to controls for placing a traditional point-to-point emergency call and for placing a multi-party emergency call.

In some embodiments, the user device may also be configured to send location information to any of the participants of the multi-party emergency call, such as to any of the emergency contact person, the medical care facility, and/or the emergency dispatch center. Such location information may be sent as textual messages indicating the current latitude and longitude of the device. Location information may in some embodiments be sent as a hyperlink to a web service that displays a map indicating the device's location.

The described techniques may be implemented within a cellular communications system, as an example. More specifically, IMS (IP multimedia subsystem) services of a cellular communications system may be used to implement conference calls and to transfer textual messages. Many of the described techniques may also be used in other environments.

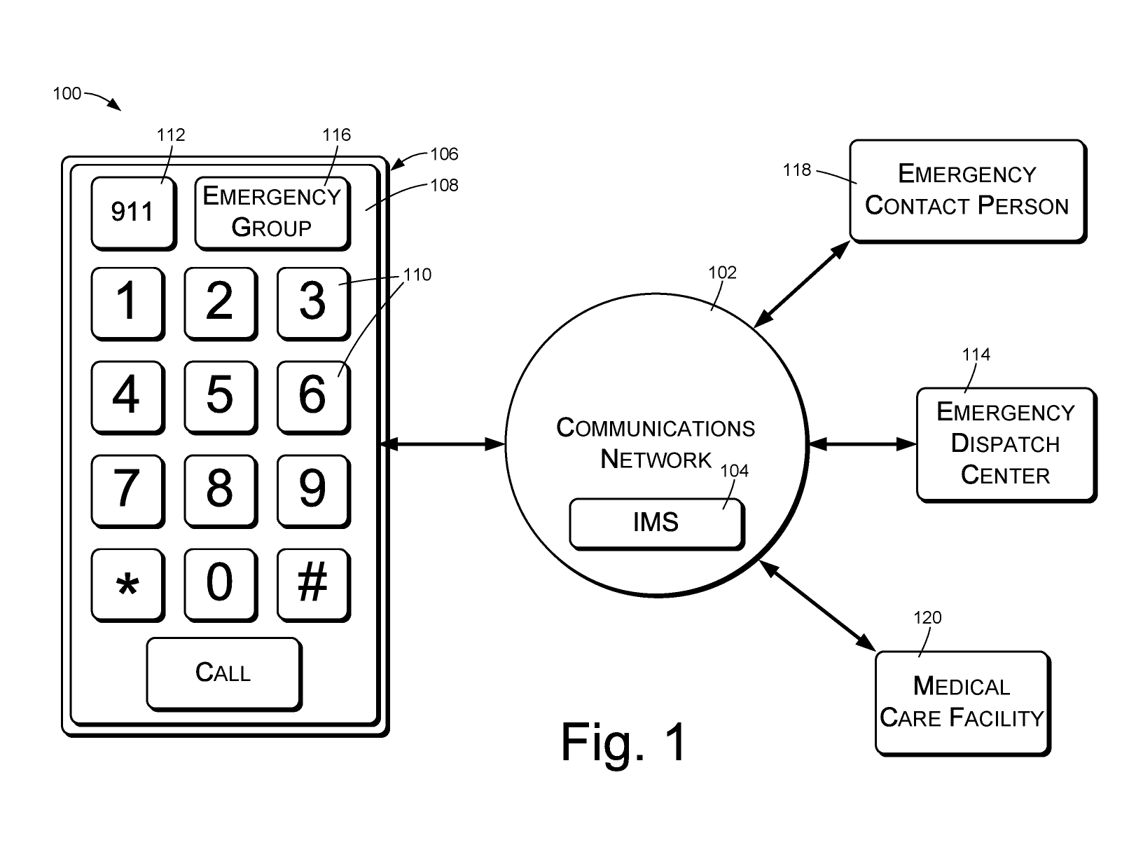

FIG. 1 illustrates an example system 100 that may be implemented to facilitate multi-party emergency calls. In this embodiment, the system 100 utilizes a communications network 102, which may, as an example, comprise an LTE (long-term evolution) wireless communication network.

The communication network 102 may implement an IMS (IP multimedia subsystem) 104, which is a standardized framework for delivering IP-based multimedia services. IMS is part of the 3GPP (3^{rd} Generation Partnership Project), which specifies the protocols and standards that are to be used within an IMS-based system.

The IMS 104 may be capable of providing communications and communication sessions of various types between devices, including voice communications, video communications, textual communications, multi-party messaging, etc. The IMS 104 may also be implemented to support multi-party voice and video communication sessions, such telephone and/or video calls having multiple participants, each of which can hear and/or see each of the other participants.

FIG. 1 shows user device 106, which may comprise a device having wireless network communication capabilities. For example, the user device 106 may be a mobile computing or communication device, a smartphone, a telephone handset, a headset, a wearable device, a computer, a personal computer, a desktop computer, a laptop computer, a tablet computer, etc. The communication capabilities of the device 106 may include Wi-Fi capabilities, cellular or other telephony capabilities, and/or other wired or wireless network communication capabilities.

In the example depicted by FIG. 1, the device 106 is assumed to communicate with other devices and entities through the communications network 102. In the LTE/IMS environment described herein, the device 106 may communicate wirelessly with components of the communications network 102 through a RAN (radio-access network, not shown) of the communications network 102.

The device 106 has a display 108 that shows different types of information depending on the state of the device 106. In the example of FIG. 1, a user of the device 106 has navigated to a dialing interface showing selectable digits or digit icons 110 that may be selected in sequence by the user of the device in order to dial telephone numbers. A user may dial the reserved emergency telephone number “911” to initiate a call to an emergency dispatch center 114.

In the example of FIG. 1, the display 108 also shows an emergency icon 112, which can be selected to automatically place an emergency call to the emergency dispatch center 114 without requiring the user to enter digits of the reserved emergency number.

The display 108 also shows an emergency multi-party calling icon 116 that can be selected by the user to initiate a multi-party emergency call. A multi-party emergency call includes one or more parties or entities in addition to the emergency dispatch center 114. For example, such a multi-party call may include an emergency contact person 118 and a medical provider center or care facility 120.

The digit icons 110, the emergency icon 112 and the emergency multi-party calling icon 116 are examples of graphical, selectable controls, any of which may be displayed at various places within the GUI (graphical user interface) of the device 106. For example, one or both of the emergency icon 112 and the emergency multi-party calling icon 116 may be displayed on the lock screen of the device 106. A lock screen is a screen configuration that is displayed by a locked or disabled device. A locked device may be unlocked by authenticating with the device, such as providing a password, scanning a fingerprint, etc. The emergency icon 112 and the emergency multi-party calling icon 116 may be active and selectable without unlocking the device in order to avoid situations in which the user might otherwise be prevented from placing emergency calls.

The user of the device 106, also referred to herein as the caller, may initiate an emergency call in different ways. For example, the user may select the appropriate digit sequence, such as “911”. In certain embodiments, the device 106 may be configured to detect that an emergency call is being initiated, and may in response automatically initiate a multi-party call including one or more parties in addition to the emergency dispatch center 114. In some embodiments, this may be a configurable feature that can be disabled by the user of the device 106.

As another example, the user may select one of the emergency calling icons 112 and 116 from the dialing screen of the device 106. As another example, the user may select one of the emergency calling icons 112 and 116 from a lock screen or other screen of the device 106 in order to initiate an emergency call.

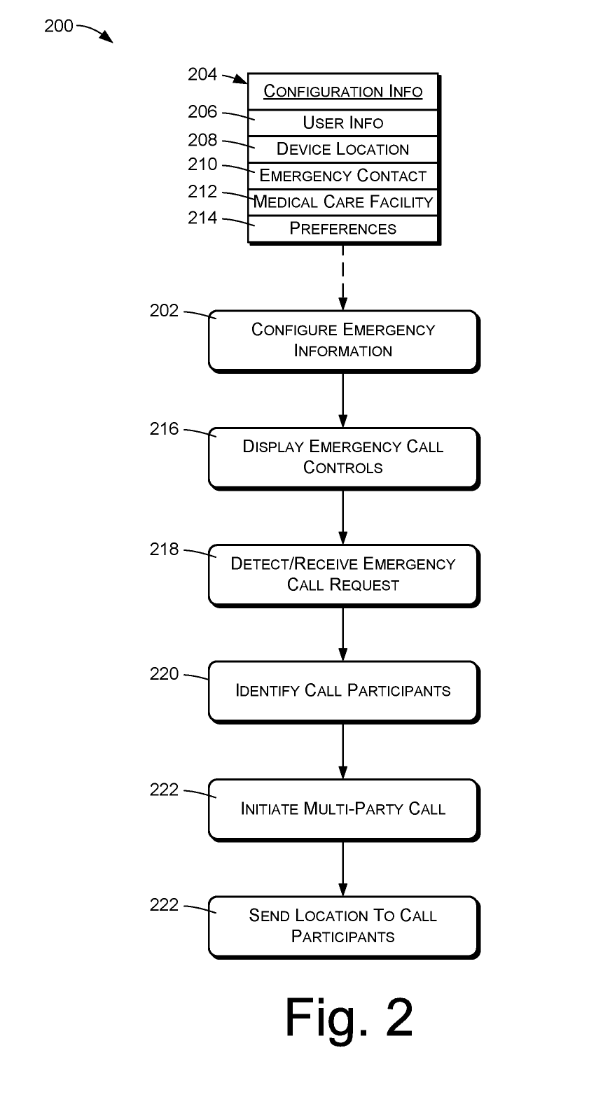

FIG. 2 illustrates an example method 200 of providing automatic emergency multi-party calling. The example method 200 may be performed, for example, by a voice communication device such as a mobile device that is supported by a cellular communications network that provides IMS services. In some embodiments, however, one or more of the actions shown in FIG. 2 may be performed by network-based services or other components external to the communication device, rather than by the communication device itself. Generally, the actions shown in FIG. 2 may be implemented in concert either alone or in concert by a communication device and/or any number of network-based components, elements, or functions.

An action 202 comprises providing, receiving, and/or configuring emergency-related configuration information 204 to be associated with the device 106. In some embodiments, at least portions of the action 202 may be performed by a manufacturer, distributor, or seller of the device prior to sale of the device to a user. In other embodiments, part or all of the emergency-related configuration information 204 may be provided by a user of the device 106 upon purchase of the device, upon first use or setup of the device, or at any other time prior to or in conjunction with placing an emergency services call.

As an example, the communication device 106 may be configured to solicit certain information from the user during initial startup of the device. As another example, the user may provide emergency-related configuration information 204 by accessing a set-up screen or dialog that is part of the user interface of the device 106. In some cases, a user may access an online service provided by the operator of the communications network 102 to provide the emergency-related configuration information 204. In some cases, the operator of the communications network 102 may maintain a database from which the configuration information 204 is obtained or received, either prior to or in conjunction with the user placing an emergency services call.

The emergency-related configuration information 204 may include user information 206, such as the name and contact information of the user of the device 106. The configuration information 204 may also include a device location 208, such as the physical address from which the device is typically used. The user information 206 and the device location 208 may be provided to an emergency dispatch center when placing a call from the device 106 to the emergency dispatch center 114. Alternatively, the user information 206 and the device location 208 may be provided to an operator of a communications network and stored by the operator for later use by services of the communications network.

The emergency-related configuration information 204 may also include emergency contact information 210, which may comprise a designation of an emergency contact person who is to be included in multi-party emergency service calls. The emergency contact information 210 may comprise a reference to a contacts database that is accessible to or from the device 106 or may comprise a telephone number of the emergency contact person. The emergency contact information 210 may indicate name of the emergency contact person and a relationship of the emergency contact person to the user of the device 106, such as whether the person is a sibling, spouse, parent, child, employer, or employee of the user.

The emergency-related configuration information 204 may in some cases indicate medical care facility information 212, indicating information about a preferred medical care facility at which the user may wish to be treated in the case of an emergency. For example, the medical care facility information 212 may comprise a telephone number of a local hospital.

Generally, the emergency-related configuration information 204 may include a designation of any number of parties or entities that are to be included in multi-party emergency calls, who may be identified by telephone numbers or other URIs (uniform resource indicators).

The emergency-related configuration information 204 may also indicate emergency call preferences 214. The emergency call preferences 214 may indicate whether the user of the device 106 wants the device 106 to automatically establish a multi-party call when the user places emergency calls. For example, the user may configure the device 106 detect that the user has dialed “911” and in response to start a multi-party call with one or more parties in addition to the emergency dispatch center 114. The emergency call preferences 214 may also indicate whether graphical icons for emergency multi-party calling should be displayed at various places within the user interface of the device 106 such as on the lock screen of the device 106, the dialing interface of the device 106, and/or at other places and times. The emergency call preferences 214 may also indicate whether emergency calling options should be presented to the user, such as whether icons for both multi-party emergency calling and non-multi-party emergency calling should be displayed.

The emergency-related configuration information 204 may be stored locally on the device 106 and/or may be provided to and stored by the operator of the communications network 102, to be obtained and used as needed by either the device itself or by components of the communications network 102.

Note that the action 202 is typically performed once, during device or account setup, and is not repeated during subsequent operation of the device 106 other than for updating provided information. Remaining actions of FIG. 2 may be performed throughout the normal operation of the device 106 and may be repeated as needed to place multiple emergency services calls.

An action 216 comprises displaying emergency call controls, such as displaying a dialing screen similar to that shown in FIG. 1. More generally, the action 216 may comprise displaying one or more controls that are selectable by the user of the device 106 to initiate an emergency call. As depicted in FIG. 1, such controls may correspond to digits for dialing a reserved emergency number such as “911” or “112”. Alternatively, or in addition, the controls may correspond to dedicated or single-purpose buttons or graphical icons that can be selected to automatically initiate an emergency services call.

An action 218 comprises detecting and/or receiving a request by the user of the device 106 to initiate an emergency call. The action 218 may comprise detecting that the user has dialed the reserved emergency number “911” or “112”, or that the user has selected one of the single-purpose buttons or graphical icons that have been displayed by the device 106 to allow a user to place emergency calls.

An action 220 comprises identifying participants to be included in a multi-party emergency call. The participants may in some cases be identified by referencing the emergency-related configuration information 204. For example, an emergency contact person and a preferred medical care facility may be identified from the emergency-related configuration information 204. The emergency dispatch center may be identified using capabilities of the IMS system, such as an E-CSCF (emergency call session control function) as will be described below. Similarly, the IMS system may implement techniques, such as look-up tables or Internet lookups to identify a suitable medical care facility that is near the location of the user. More specifically, upon determining a location of a calling user, the IMS system may perform an Internet search to identify the nearest emergency room that is available to the user. Alternatively, the IMS system may maintain a database indicating available emergency rooms and their locations.

An action 222 comprises responding to detecting or receiving the request to initiate an emergency call. More specifically, the action 220 comprises initiating a multi-party voice call with (a) the user of the device 106, (b) the emergency dispatch center 114, and (c) the emergency contact person 118 as specified by the configuration information 204. In certain embodiments, the multi-party voice call may also be with (d) the medical care facility 120 indicated by the configuration information 204.

Note that the term “voice call” or “multi-party voice call” is not meant to exclude communications that include other media types in addition to voice, such as video or text.

An action 224 comprises sending an indication of the location of the communication device to any one or more of the emergency contact person, the medical care facility, and the emergency dispatch center. For example, the action 224 may comprise sending a textual message to any of these parties, particularly to the parties other than the emergency dispatch center, containing geographical coordinates such as latitude and longitude of the communication device as determined by GPS (global positioning system) components of the communication device. Such a textual message may comprise an SMS (short messaging service) message or a message sent using other means such as by using services of the IMS system 104. IMS messages can be sent and received in accordance with technical specification TS 22.440 Release 13 of the 3^{Rd} Generation Partnership Project (3GGP).

The textual message may also, or alternatively, include a hyperlink to an online mapping service, wherein the hyperlink is selectable by its recipient to navigate to the online mapping service and to show a map indicating the current geographic location of the device 106. In some embodiments a message such as this may contain an image of a map that indicates the current geographic location of the device 106.

The nature of such textual messages, whether or not the messages are sent, and the parties to which the message are sent may be configured by the user as part of the preferences 214. The textual messages in some cases may be sent whether or not multiple parties are invited to the multi-party voice call and whether or not individual ones of the parties actually join or participate in the voice call.

The textual messages may contain other information, and may in some cases be used simply to notify additional parties that the user of the device has called emergency services.

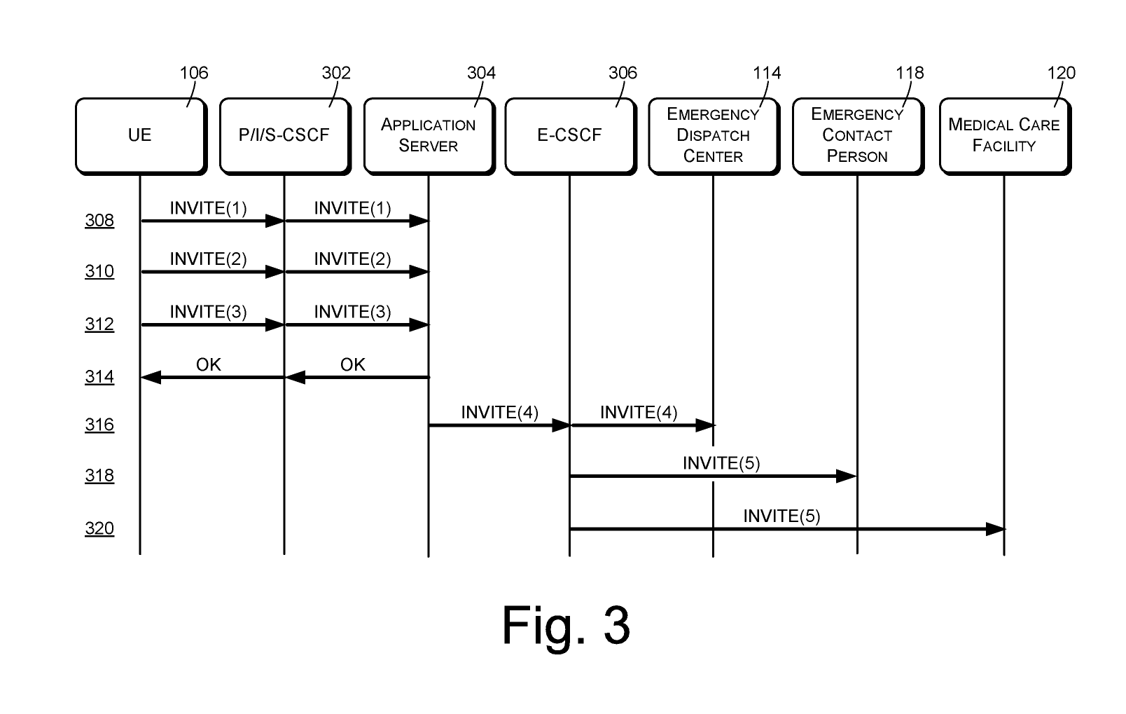

FIG. 3 shows relevant elements of an IMS system that may be used to facilitate the placement and/or creation of emergency service calls as described herein, including multi-party calls that are directed in part to emergency services. In addition, FIG. 3 show high-level communications that may occur when setting up a multi-party emergency call.

Communications are indicated by arrows that extend from and to the vertical lines corresponding to the entities from which the communications originate and terminate, respectively. Communications occur in order from top to bottom. An individual communication or set of communications is indicated by a corresponding reference numeral along the left side of FIG. 3, horizontally aligned with the arrow or arrows representing the communication. Note that FIG. 3 illustrates the most relevant communications and may omit other communications that occur in practice but are less relevant to the topics at hand Such other communications may include communications that both precede and follow the illustrated communications, communications that occur in time between the illustrated communications, and communications that occur between components or entities that are not specifically shown.

Generally, multi-party communication sessions, referred to in the IMS environment as conference calls, are set up using SIP (session initiation protocol) messages in accordance with technical specification TS 24.147 of the 3GPP. Emergency calls using IMS services may be established in accordance with technical specification TS 23.167 of the 3GPP.

The components of the IMS system 104 include multiple call session control functions CSCFs that receive, act upon, and/or forward SIP messages. The CSCFs may include proxy CSCFs, interrogating CSCFs, and serving CSCFs, which are collectively referred to herein as P/I/S-CSCFs 302.

An IMS system may also include an RCS (rich communication services) application server 304. Among other services, the application server 304 may provide voice and/or video conferencing services.

Generally, a P-CSCF acts as a gateway to the IMS system 104. Communications flow from the UE 106, to a P-CSCF that has been designated for use by the UE, to an I-CSCF, and to an S-CSCF. The S-CSCF may then forward communications to an appropriate application server 304 or to the S-CSCF associated with a termination device.

The components of the IMS system 104 may also include one or more emergency CSCFs (E-CSCFs) 306. The E-CSCF 306 is responsible for handing emergency service calls. A call request directed to emergency services is forwarded to the E-CSCF 306, which identifies an appropriate emergency dispatch center 114 based on the location of the user, and forwards the request to that emergency dispatch center 114.

In the case of an emergency multi-party call placed by the UE 106 through the IMS system, at 308, 310, and 312 of FIG. 3 the UE 106 sends individual SIP INVITE messages to the application server 304 through the P/I/S-CSCF 302. The SIP INVITE messages correspond respectively to the parties to be included in the multi-party emergency call, which in the described embodiment may comprise one or more of the emergency dispatch center 114, an emergency contact person 118, and the medical care facility 120. In the case of the INVITE message corresponding to the emergency dispatch center 114, the SIP INVITE message specifies a generic recipient address of “911”. For the emergency contact person 118, the corresponding SIP INVITE message specifies the person's telephone number. For the medical care facility 120, the SIP INVITE message specifies the telephone number of the medical care facility. Each INVITE message indicates that it is for an ad-hoc audio conference to be created by the IMS system.

All three different INVITEs specify one conference ID indicator, created by the P-CSCF, indicating that the call will need to be conferenced by a MRF (Media Resource Function) of the IMS system. In the described embodiment, P-CSCFs, application servers, and MRFs of the IMS system are configured to support this type of conferencing setup.

The application server 304, in conjunction with an MRF (media resource function, not shown) creates a contact URI (universal resource identifier) for a conference call and at 314 returns it to the requesting UE 106 as part of an “OK” acknowledgement message to the UE 106.

At 316, 318, and 320, INVITEs are sent by the application server 304 to other requested participants of the multi-party call. In practice, the INVITEs are forwarded through appropriate CSCFs associated with the individual participants (these CSCFs are not shown in FIG. 3). In the case of the INVITE to the emergency dispatch center 114, the application server 304 recognizes that the INVITE is directed to the “911” reserved number and that the INVITE is therefore to an emergency dispatch center. Thus, the INVITE to the emergency dispatch center is sent initially to the E-CSCF 306. The E-CSCF 306 identifies the appropriate emergency dispatch center 114 and sends an INVITE message to that dispatch center 114. This INVITE message may also pass through one or more CSCFs (not shown) associated with the emergency dispatch center 114.

The various INVITE messages sent by the application server 304 indicate the contact URI that has been established for the conference call. The receiving entities then join the conference call using in accordance with established IMS and SIP messaging protocols.

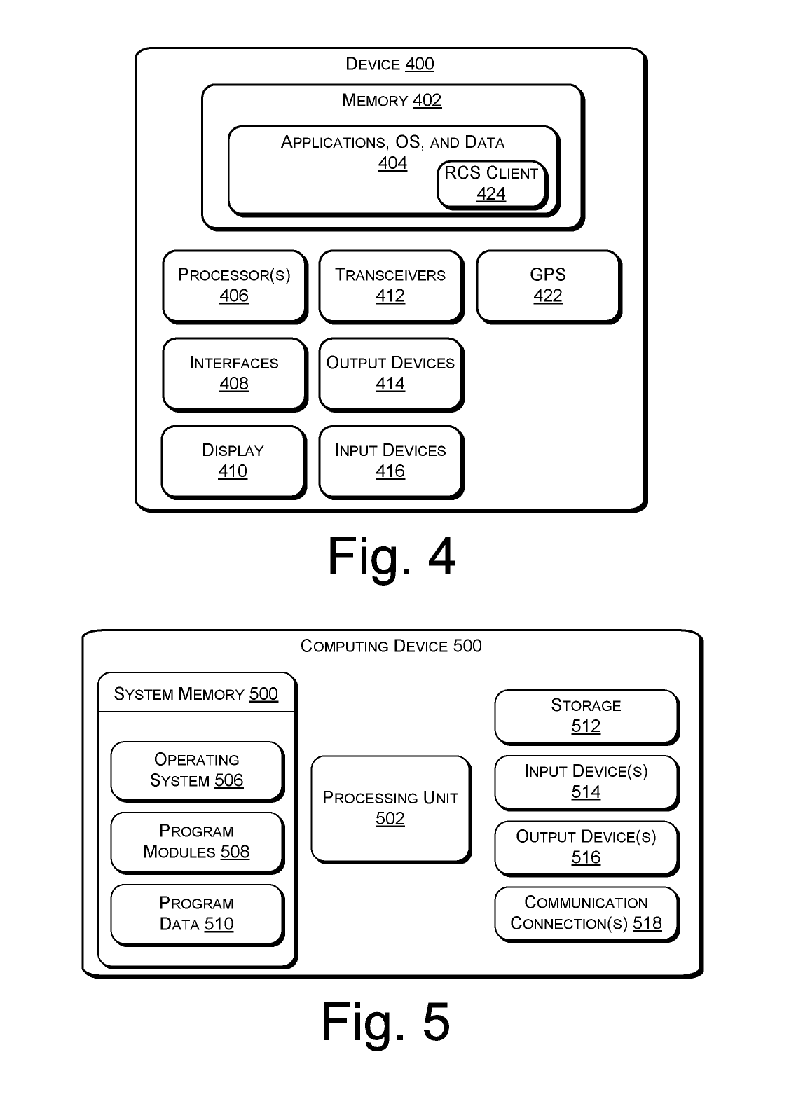

FIG. 4 illustrates an example device 400 in accordance with various embodiments. The device 400 illustrates an example of the UE 106, as well as of other communication devices that may be used for communications by the emergency dispatch center 114, the emergency contact person 118, and the medical care facility 120. Generally, the UE 106 may be any type of voice communication device that connects to a communication network for communications with other communication devices.

The device 400 may include memory 402, which may store applications, an operating system (OS), and data 404. The device 400 further includes processor(s) 406, interfaces 408, a display 410, radio transceivers 412, output devices 414, and input devices 416.

In various embodiments, the memory 402 includes both volatile memory and non-volatile memory. The memory 402 stores one or more sets of instructions (e.g., software) such as a computer-executable program that embodies operating logic for implementing and/or performing any one or more of the methodologies or functions described herein. The instructions may also reside, completely or at least partially, within the memory 402 and within the processor 406 during execution thereof by the device 400.

The memory 402 comprises non-transitory computer storage media, which includes various forms of computer-readable memory. The memory 402 may include removable and non-removable media implemented in any method or technology for storage of information, such as computer readable instructions, data structures, program modules, or other data. Additionally, in some embodiments, the memory 402 may include a SIM (subscriber identity module), which is a removable smart card used to identify a user of the device 400 to a service provider network.

The memory 402 may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the device 400. Any such non-transitory computer-readable media may be part of the device 400 or can be external to the device 400.

In some embodiments, the Applications, OS, and data 404 may include an RCS client 424, which may comprise an application or other software components for performing RCS communications with IMS application servers as described above.

In some embodiments, the processor(s) 406 is a central processing unit (CPU), a graphics processing unit (GPU), or both CPU and GPU, or other processing unit or component known in the art.

In various embodiments, the interfaces 408 are any sort of interfaces known in the art. The interfaces 408 may include any one or more of an Ethernet interface, wireless local-area network (WLAN) interface, a cellular communications interface, a near field interface, a DECT chipset, or an interface for an RJ-11 or RJ-45 port. A wireless LAN interface can include a Wi-Fi interface or a Wi-Max interface, or a Bluetooth interface that performs the function of transmitting and receiving wireless communications using, for example, the IEEE 702.11, 702.16 and/or 702.20 standards. The near field interface can include a Bluetooth® interface or radio frequency identifier (RFID) for transmitting and receiving near field radio communications via a near field antenna. For example, the near field interface may be used for functions, as is known in the art, such as communicating directly with nearby devices that are also, for instance, Bluetooth® or RFID enabled.

In various embodiments, the display 410 may comprise a liquid crystal display or any other type of display commonly used in telecommunication devices or other portable devices. For example, display 410 may be a touch-sensitive display screen, which may also act as an input device or keypad, such as for providing a soft-key keyboard, navigation buttons, or the like.

The transceivers 412 include any sort of transceivers known in the art. For example, the transceivers 412 may include radio radios and/or radio transceivers and interfaces that perform the function of transmitting and receiving radio frequency communications via an antenna, through a cellular communication network of a wireless data provider. The radio interfaces facilitate wireless connectivity between the device 400 and various cell towers, base stations and/or access points.

The output devices 414 include any sort of output devices known in the art, such as a display (already described as display 410), speakers, a vibrating mechanism, or a tactile feedback mechanism. The output devices 414 also include ports for one or more peripheral devices, such as headphones, peripheral speakers, or a peripheral display.

The input devices 416 include any sort of input devices known in the art. For example, the input devices 416 may include a microphone, a keyboard/keypad, or a touch-sensitive display (such as the touch-sensitive display screen described above). A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

The device 400 may also have a GPS (global positioning system) receiver 422 for determining the current location of the device 400 based on signals received from satellites.

FIG. 5 is a block diagram of an illustrative computing device 500 such as may be used to implement various components or functions of the communications network 102, including servers, routers, gateways, administrative components, etc. For example, one or more computing devices 500 may be used to implement any of the CSCFs 302, the application server, and the E-CSCF 306.

In various embodiments, the computing device 500 may include at least one processing unit 502 and system memory 504. Depending on the exact configuration and type of computing device, the system memory 504 may be volatile (such as RAM), non-volatile (such as ROM, flash memory, etc.) or some combination of the two. The system memory 504 may include an operating system 506, one or more program modules 508, and may include program data 510.

The computing device 500 may also include additional data storage devices 512 (removable and/or non-removable) such as, for example, magnetic disks, optical disks, or tape.

Non-transitory computer storage media of the computing device 500 may include volatile and nonvolatile, removable and non-removable media implemented in any method or technology for storage of information, such as computer readable instructions, data structures, program modules, or other data. The system memory 504 and storage 512 are all examples of computer-readable storage media. Non-transitory computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such non-transitory computer-readable storage media may be part of the computing device 500.

In various embodiment, any or all of the system memory 504 and storage 512 may store programming instructions which, when executed, implement some or all of the function functionality described above as being implemented by the communications network 102 and/or any components of the communications network 102, including elements and functions of the IMS system 104.

The computing device 500 may also have input device(s) 514 such as a keyboard, a mouse, a touch-sensitive display, voice input device, etc. Output device(s) 516 such as a display, speakers, a printer, etc. may also be included. The computing device 500 may also contain communication connections 518 that allow the device to communicate with other computing devices.

Although features and/or methodological acts are described above, it is to be understood that the appended claims are not necessarily limited to those features or acts. Rather, the features and acts described above are disclosed as example forms of implementing the claims.

1. A communication device comprising:
one or more processors;
one or more non-transitory computer-readable media storing computer-executable instructions that, when executed by the one or more processors, cause the one or more processors to perform actions comprising:
receiving a designation of an emergency contact person associated with a user of the communication device;
displaying one or more controls that are selectable by a user of the communication device to initiate an emergency call; and
responding to selection of the one or more controls by initiating a multi-party voice call between (a) the user of the communication device, (b) an emergency dispatch center, and (c) the emergency contact person, a medical provider center, or both.

2. The communication device of claim 1, wherein the multi-party voice call is further with (d) a medical care facility.

3. The communication device of claim 1, the actions further comprising soliciting a telephone number of the emergency contact person during configuration of the communication device prior to the selection of the one or more selectable controls, wherein the multi-party voice call is established using the telephone number of the emergency contact person.

4. The communication device of claim 1, wherein the one or more controls corresponds to digits that can be selected in sequence to specify a number that has been designated as an emergency telephone number.

5. The communication device of claim 1, wherein the one or more controls comprise a graphical icon that is selectable to initiate the emergency call.

6. The communication device of claim 1, the actions further comprising sending a textual message to the emergency contact person in response to selection of the one or more controls, the textual message indicating a location.

7. The communication device of claim 1, the actions further comprising sending a textual message to each of the emergency contact person and a medical care facility in response to selection of the one or more controls, the textual message indicating a location.

8. A method, comprising:
receiving a request to initiate a voice call between a communication device and an emergency dispatch center;
receiving a telephone number of an emergency contact person associated with a user of the communication device; and
in response to receiving the request to initiate the voice call, initiating a multi-party voice call between (a) the communication device, (b) a device associated with the emergency dispatch center, and (c) a device associated with the telephone number of the emergency contact person, a medical provider center, or both.

9. The method of claim 8, wherein the multi-party voice call is further with (d) a medical care facility.

10. The method of claim 8, further comprising:
receiving a location of the communication device;
identifying a medical care facility that is available to the user of the communication device; and
wherein the multi-party voice call is further with (d) the medical care facility.

11. The method of claim 8, wherein the request comprises selection by a user of the communication device of one or more selectable controls of the communication device.

12. The method of claim 8, further comprising soliciting the telephone number of the emergency contact person during configuration of the communication device prior to receiving the request to initiate the voice call.

13. The method of claim 8, further comprising sending an indication of the location of the communication device to the telephone number of the emergency contact person.

14. The method of claim 8, further comprising sending an indication of the location of the communication device to the emergency contact person and to a medical care facility.

15. One or more non-transitory computer storage media with a stored computer-executable program, which, when executed by one or more processors, performs actions comprising:
receiving a request to initiate an emergency voice call; and
in response to receiving the request to initiate the emergency voice call, initiating a multi-party voice call between at least three entities, the at least three entities including a caller and an emergency dispatch center.

16. The one or more non-transitory computer storage media of claim 15, the at least three entities further including a person who has been designated as an emergency contact person by the caller.

17. The one or more non-transitory computer storage media of claim 15, the at least three entities further including a medical care facility.

18. The one or more non-transitory computer storage media of claim 15, the actions further comprising:
receiving a location of the communication device;
identifying a medical care facility that is available to the caller; and
wherein the at least three entities include the medical care facility.

19. The one or more non-transitory computer storage media of claim 15, the actions further comprising sending an indication of the location of the caller to an emergency contact person that has been designated by the caller.

20. The one or more non-transitory computer storage media of claim 15, the actions further comprising sending an indication of the location of the caller to a medical care facility that is available to the caller.
